(19) United States
(12) Patent Application Publication
(10) Pub. No.: US 2025/0063241 A1
(43) Pub. Date: Feb. 20, 2025

(54) IMAGING SYSTEM

(71) Applicant: Japan Display Inc., Tokyo (JP)

(72) Inventor: Junji KOBASHI, Tokyo (JP)

(21) Appl. No.: 18/797,955

(22) Filed: Aug. 8, 2024

(30) Foreign Application Priority Data
Aug. 14, 2023 (JP) 2023-131792

(51) Int. Cl. H04N 23/10; H04N 7/15; H04N 23/84

(52) U.S. Cl. CPC H04N 23/125; H04N 23/84; H04N 7/15

(57) ABSTRACT

An imaging system includes a display device that has a display panel, and an imaging device that is disposed such that the display panel is interposed between an object to be imaged and the imaging device, and takes an image of the object to be imaged, the image being transmitted through the display panel. The imaging device acquires light exposure data of a color different from a display color on the display device to generate imaging data of the object to be imaged.

### CROSS-REFERENCE TO RELATED APPLICATION

This application claims the benefit of priority from Japanese Patent Application No. 2023-131792 filed on Aug. 14, 2023, the entire contents of which are incorporated herein by reference.

### BACKGROUND

### 1. Technical Field

The present invention relates to an imaging system.

### 2. Description of the Related Art

Teleconferencing systems via networks are widely used. In such a teleconferencing system, images of participants taken by web cameras installed or embedded above monitors, for example, are generally displayed on a screen of each terminal. Such a configuration, in which the line of sight of the participant looking at the monitor does not match the line of sight of the participant displayed on the screen, may cause deterioration in the quality of communication. As a conventional example of such a configuration, a display device with a camera in which an imaging module (camera) is built into a display element (display unit), a communication device, and a communication system are disclosed (for example, Japanese Patent Application Laid-open Publication No. 2005-176151).

In the above conventional technique, the display drive of the display element and the imaging drive of the imaging module are performed alternately. This may cause flickering of the displayed and taken images, which may cause deterioration in the display quality and imaging quality.

### SUMMARY

An imaging system according to an embodiment of the present disclosure includes a display device that has a display panel, and an imaging device that is disposed such that the display panel is interposed between an object to be imaged and the imaging device, and takes an image of the object to be imaged, the image being transmitted through the display panel. The imaging device acquires light exposure data of a color different from a display color on the display device to generate imaging data of the object to be imaged.

### BRIEF DESCRIPTION OF THE DRAWINGS

FIG. 1 is a diagram illustrating a schematic configuration of an imaging system according to an embodiment;

FIG. 2 is a schematic circuit diagram illustrating a major configuration of a display device;

FIG. 3 is a schematic cross-sectional view of a display panel;

FIG. 4 is a timing chart illustrating subframe periods and light emission periods in a one-frame period in which display image data is displayed;

FIG. 5 is a diagram illustrating a color filter array of an image sensor;

FIG. 6 is a timing chart illustrating a relation between an image display timing and an acquisition timing of imaging data according to a first embodiment;

FIG. 7 is a timing chart illustrating a relation between the image display timing and the acquisition timing of the imaging data according to a second embodiment; and

FIG. 8 is a diagram illustrating a color filter array of the image sensor according to a modification.

### DETAILED DESCRIPTION

The following describes embodiments of the present disclosure in detail with reference to the accompanying drawings. The present disclosure is not limited by what is described in the following embodiments. Components to be described below include those easily conceivable by those skilled in the art or those substantially identical thereto. In addition, the components to be described below can be combined as appropriate. What is disclosed herein is merely an example, and the present disclosure naturally encompasses appropriate modifications easily conceivable by those skilled in the art while maintaining the gist of the present disclosure. To further clarify the description, the drawings may schematically illustrate, for example, widths, thicknesses, and shapes of various parts as compared with actual aspects thereof. However, they are merely examples, and interpretation of the present disclosure is not limited thereto. The same component as that described with reference to an already mentioned drawing is denoted by the same reference numeral through the present specification and the drawings, and detailed description thereof may not be repeated where appropriate.

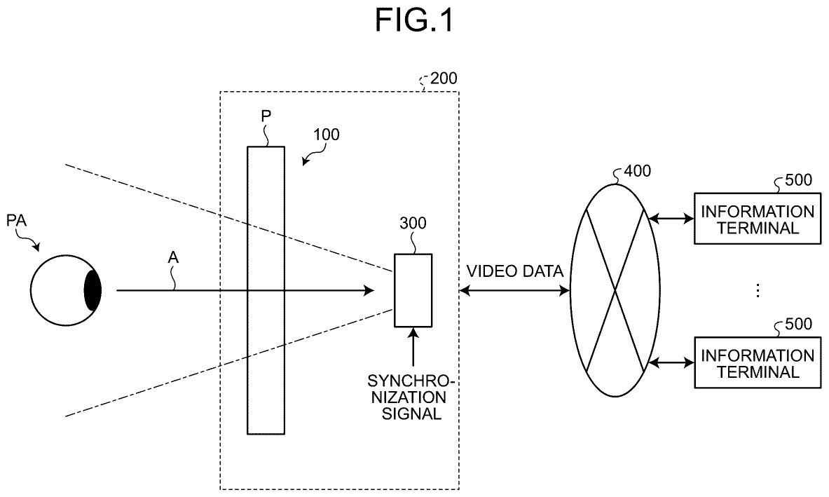

FIG. 1 is a diagram illustrating a schematic configuration of an imaging system according to an embodiment. As illustrated in FIG. 1, this imaging system 200 according to the embodiment includes a display device 100 and an imaging device 300.

In the present disclosure, the display device 100 is a liquid crystal display device that performs display output by what is called a field sequential color (FSC) method, in which pixels are controlled such that the single pixel transmits each of light beams of a plurality of colors at different timings.

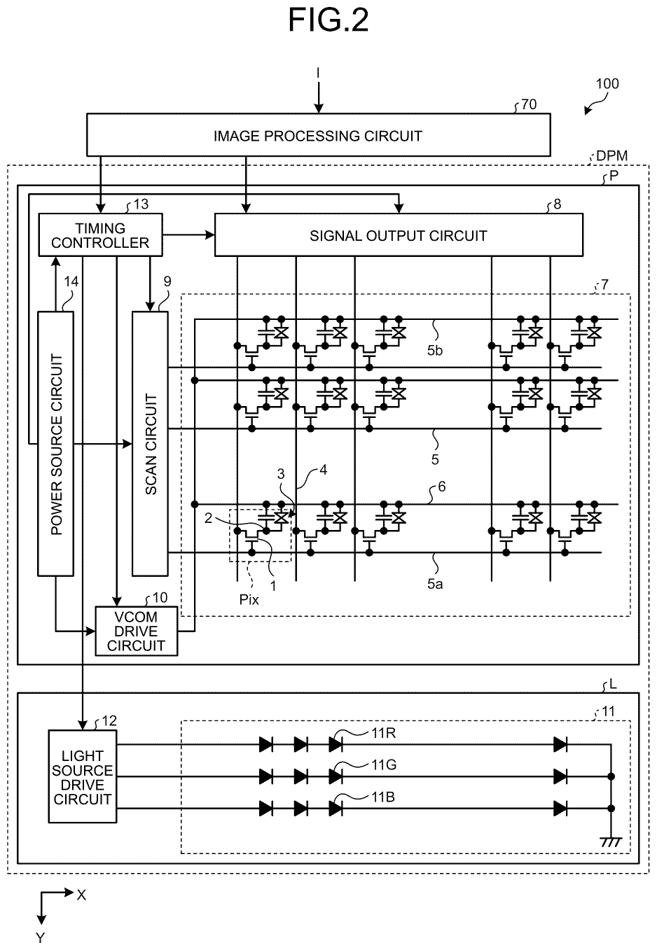

FIG. 2 is a schematic circuit diagram illustrating a major configuration of the display device. The display device 100 includes a display panel module DPM and an image processing circuit 70. The display panel module DPM includes a display panel P and a light source unit L.

The display panel P includes a display region 7, a signal output circuit 8, a scan circuit 9, a VCOM drive circuit 10, a timing controller 13, and a power source circuit 14. Hereafter, one surface on which the display region 7 is present of the display panel P is referred to as the display surface and the other surface is referred to as the back surface. When described as a lateral side of the display device 100, it refers to a side in a direction that intersects (e.g., orthogonally) with the direction in which the display surface and the back surface of the display device 100 face each other.

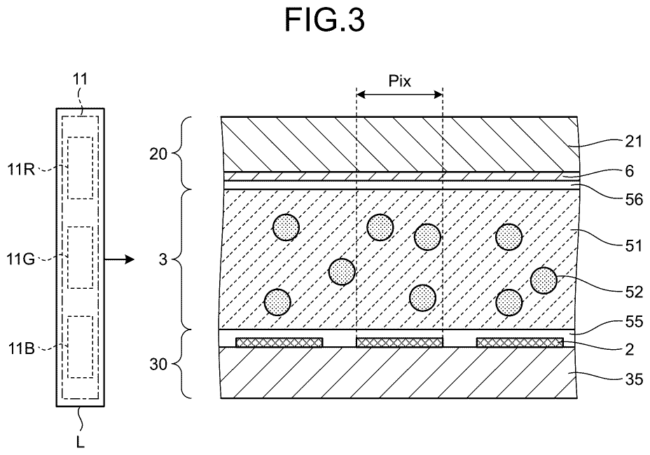

A plurality of pixels Pix are arranged in a matrix having a row-column configuration in the display region 7. The pixel Pix includes a switching element 1 and two electrodes. FIG. 3 is a schematic cross-sectional view of the display panel. In FIGS. 2 and 3, the two electrodes are illustrated as a pixel electrode 2 and a common electrode 6.

The display panel P has two substrates facing each other and a liquid crystal 3 sealed between the two substrates. Hereafter, one of the two substrates is referred to as a first substrate 30 and the other as a second substrate 20.

The first substrate 30 includes a light transmissive glass substrate 35, pixel electrodes 2 stacked on the second substrate 20 side of the glass substrate 35, and an insulating layer 55 stacked on the second substrate 20 side to cover the pixel electrodes 2. The pixel electrode 2 is provided individually for each pixel Pix. The second substrate 20 includes a light transmissive glass substrate 21, the common electrode 6 stacked on the first substrate 30 side of the glass substrate 21, and an insulating layer 56 stacked on the first substrate 30 side to cover the common electrode 6. The common electrode 6 has a plate or film shape that is shared by the pixels Pix.

The liquid crystal 3 in a first embodiment is a polymer dispersed liquid crystal. Specifically, the liquid crystal 3 includes a bulk material 51 and fine particles 52. The fine particles 52 change the orientation in the bulk material 51 depending on the potential difference between the pixel electrode 2 and the common electrode 6. The potential of the pixel electrode 2 is individually controlled for each pixel Pix, resulting in the scattering state of the liquid crystal 3 being controlled for each pixel Pix.

FIG. 3 illustrates an example in which the pixel electrodes 2 and the common electrode 6 are arranged opposite each other with the liquid crystal 3 interposed therebetween. The display panel P may include the pixel electrodes 2 and the corresponding common electrode 6 that are provided on a single substrate. In this configuration, the orientation may be changed by an electric field generated by the pixel electrode 2 and the common electrode 6, resulting in the scattering state of the liquid crystal 3 being controlled.

The following describes a principle of controlling the potentials of the pixel electrode 2 and the common electrode 6.

The switching element 1 uses a semiconductor such as a thin film transistor (TFT), for example. One of a source and a drain of the switching element 1 is coupled to one (the pixel electrode 2) of the two electrodes. The other of the source and the drain of the switching element 1 is coupled to a signal line 4. A gate of the switching element 1 is coupled to a scan line 5. The scan line 5 provides the potential to open and close between the source and the drain of the switching element 1 under the control of the scan circuit 9. The scan circuit 9 controls the potential.

In the example illustrated in FIG. 2, the signal lines 4 are aligned in one (a row direction) of the alignment directions of the pixels Pix. The signal line 4 extends along the other (a column direction) of the alignment directions of the pixels Pix. The signal line 4 is shared by the switching elements 1 having the pixels Pix aligned in the column direction. The scan lines 5 are aligned in the column direction. The scan line 5 extends along the row direction. The scan line 5 is shared by the switching elements 1 having the pixels Pix aligned in the row direction.

In the present disclosure, the direction in which the scan line 5 extends is the X direction while the direction in which the scan lines 5 are aligned is the Y direction. In FIG. 2, one of the scan lines 5 located at both ends in the Y direction is denoted as a scan line 5a and the other as a scan line 5b.

The common electrode 6 is coupled to the VCOM drive circuit 10. The VCOM drive circuit 10 applies a common potential to the common electrode 6.

While the scan circuit 9 supplies a potential that serves as a drive signal to the scan line 5 to control the switching element 1 to be turned on, the signal output circuit 8 supplies a pixel signal to the signal line 4, which causes a storage capacitance formed between the pixel electrode 2 and the common electrode 6 and the liquid crystal 3 (the fine particles 52), which is a capacitive load, to be charged. As a result, a voltage depending on the pixel signal is applied between the pixel electrode 2 and the common electrode 6.

After the switching element 1 is turned off, the applied voltage between the pixel electrode 2 and the common electrode 6 is held by the storage capacitance and the liquid crystal 3 (the fine particles 52), which is the capacitive load. The degree of scattering of the liquid crystal 3 (the fine particles 52) is controlled depending on the applied voltage between the pixel electrode 2 and the common electrode 6 for each pixel Pix. The liquid crystal 3 may be a polymer dispersed liquid crystal having characteristics that the degree of scattering increases as the applied voltage between the pixel electrode 2 and the common electrode 6 for each pixel Pix increases. Alternatively, the liquid crystal 3 may be a polymer dispersed liquid crystal having characteristics that the degree of scattering increases as the applied voltage between the pixel electrode 2 and the common electrode 6 for each pixel Pix decreases.

As illustrated in FIG. 3, the light source unit L is disposed on the lateral side of the display panel P (on the side under the display panel P in FIG. 2). The light source unit L includes a light source 11 that emits light to the side of the display panel P and a light source drive circuit 12 that controls the light source 11. The light source 11 includes a first light source 11R, a second light source 11G, and a third light source 11B.

The first light source 11R, the second light source 11G, and the third light source 11B each emit light under the control of the light source drive circuit 12. The first light source 11R, the second light source 11G, and the third light source 11B are light sources using light emitting devices such as light emitting diodes (LEDs), for example, but are not limited thereto. The first light source 11R, the second light source 11G, and the third light source 11B may be light sources that can control light emission timings.

The light source drive circuit 12 controls the light emission timing of the first light source 11R, the second light source 11G, and the third light source 11B under the control of the timing controller 13. In the present disclosure, the light emission color (a first color) of the first light source 11R is red (R), the light emission color (a second color) of the second light source 11G is green (G), and the light emission color (a third color) of the third light source 11B is blue (B).

When light is emitted from the light source 11, the display region 7 is illuminated with light (the first, the second, and third colors) emitted from the lateral side in the Y direction. Each pixel Pix transmits or scatters light emitted from the lateral side in the Y direction. The degree of scattering of the liquid crystal 3 for each pixel Pix depends on the state of the liquid crystal 3 controlled depending on the pixel signal for each pixel Pix.

The timing controller 13 is a circuit that controls the operation timings of the signal output circuit 8, the scan circuit 9, the VCOM drive circuit 10, and the light source drive circuit 12. In the present disclosure, the timing controller 13 operates on the basis of signals input thereto via the image processing circuit 70.

The image processing circuit 70 outputs signals based on display image data I to the signal output circuit 8 and the timing controller 13. The data indicating the RGB gradation value assigned to one pixel Pix among the pixels Pix provided in the display region 7 is defined as pixel data. The display image data I input to the image processing circuit 70 to output the display image is a set of a plurality of pieces of pixel data for each pixel Pix in the display region 7. The image processing circuit 70 may be provided on one of the substrates included in the display panel P, may be mounted on a flexible printed circuit board on which wiring lines extending from the display panel P and the like are provided, or may be provided outside the display panel P.

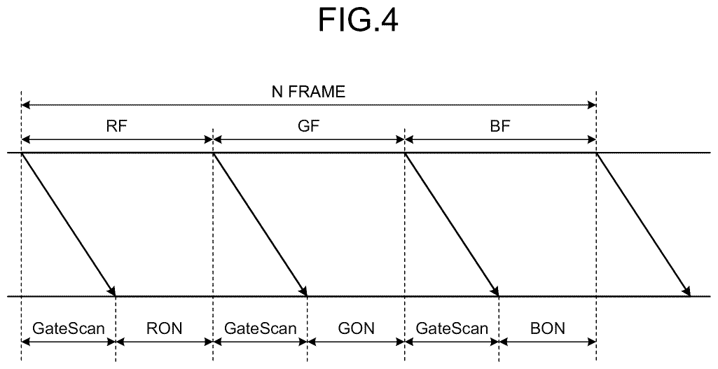

FIG. 4 is a timing chart illustrating subframe periods and light emission periods in a one-frame period in which the display image data is displayed. FIG. 4 exemplarily illustrates the Nth one-frame period. Specifically, the display device 100 displays the display image data I at 60 frames per second (FPS), for example.

As illustrated in FIG. 4, in the display device 100 that performs display output by the FSC method, the image display period of one frame (the one-frame period) based on the display image data I is temporally divided into a first subframe period RF, a second subframe period GF, and a third subframe period BF.

In a vertical scan period GateScan in the first subframe period RF, the pixel data depending on the output gradation value of each pixel Pix corresponding to the first color (red (R)) of the display image data I (N) is written. As a result, the voltage depending on the pixel data for each pixel Pix is applied to the pixel electrode 2, and the scattering state of the liquid crystal 3 for each pixel Pix is controlled according to the applied voltage to the pixel electrode 2.

The first light source 11R is emitted in a light emission period RON following the vertical scan period GateScan. In the light emission period RON, light in the first color (red (R)) depending on the pixel data for each pixel Pix written in the previous vertical scan period GateScan is scattered and displayed.

In the vertical scan period GateScan in the second subframe period GF, the pixel data depending on the output gradation value of each pixel Pix corresponding to the second color (green (G)) of the display image data I (N) is written. As a result, the voltage depending on the pixel data for each pixel Pix is applied to the pixel electrode 2, and the scattering state of the liquid crystal 3 for each pixel Pix is controlled according to the applied voltage to the pixel electrode 2.

The second light source 11G is emitted in a light emission period GON following the vertical scan period GateScan. In the light emission period GON, light in the second color (green (G)) depending on the pixel data for each pixel Pix written in the previous vertical scan period GateScan is scattered and displayed.

In the vertical scan period GateScan in the third subframe period BF, the pixel data depending on the output gradation value of each pixel Pix corresponding to the third color (blue (B)) of the display image data I (N) is written. As a result, the voltage depending on the pixel data for each pixel Pix is applied to the pixel electrode 2, and the scattering state of the liquid crystal 3 for each pixel Pix is controlled according to the applied voltage to the pixel electrode 2.

The third light source 11B is emitted in a light emission period BON following the vertical scan period GateScan. In the light emission period BON, light in the third color (blue (B)) depending on the pixel data for each pixel Pix written in the previous vertical scanning period GateScan is scattered and displayed.

In the display device 100 based on the FSC method, an image in which the first (red (R)), the second (green (G)), and the third (blue (B)) colors, i.e., three colors, are combined (mixed) is recognized due to an afterimage phenomenon caused by the limited temporal resolution in human eyes. The display device 100 based on the FSC method does not require a color filter for each pixel Pix, making it possible to increase a light transmittance in the display region 7.

Returning to FIG. 1, the imaging device 300 is a digital camera that includes an imaging element and an imaging lens that focuses light onto the imaging element. An example of the imaging element is a solid state imaging element such as a complementary metal oxide semiconductor (CMOS) image sensor. The imaging element is not limited to the example, and may be a charge coupled device (CCD) image sensor, for example.

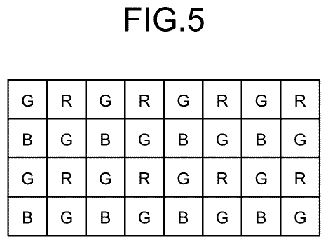

The image sensor includes color filters each of which selectively transmits the first (red (R)), the second (green (G)), and the third (blue (B)) colors. FIG. 5 is a diagram illustrating a color filter array of the image sensor.

The color filter array of the image sensor illustrated in FIG. 5 exemplarily illustrates a Bayer array. The Bayer array consists of three primary color filters of red (R), green (G), and blue (B). A combination of four R/G/G/B pixels is regularly repeated. Specifically, the first color (red (R)) filter, the third color (blue (B)) filter, and two second color (green (G)) filters are arranged in 2×2 pixels. The color filter array of the image sensor illustrated in FIG. 5 is an example, and is not limited to the example illustrated in FIG. 5.

As illustrated in FIG. 1, in the present disclosure, the imaging device 300 is disposed such that the display device 100 based on the FSC method is interposed between the imaging device 300 and an object to be imaged PA. The object to be imaged PA is a participant in a teleconference system, for example. More preferably, the imaging system 200 according to the embodiment has the imaging device 300 disposed on the vertical line of a line of sight A looking at the display panel P from the object to be imaged PA.

The image of the object to be imaged PA passes through the display panel P and forms an image on the imaging element of the imaging device 300, thus being captured as image data. Specifically, the imaging device 300 captures the image data of the object to be imaged PA at 90 FPS, for example. In the following description, the image data acquired by the imaging device 300 is also referred to as the “imaging data”.

The image data captured by the imaging device 300 is distributed as video data via a network 400 to information terminals 500 of participants in the teleconferencing system, for example. Examples of the information terminals 500 include desktop and notebook personal computers. The imaging system 200 according to the embodiment may include displays, web cameras, and like that are included in the information terminals 500, for example.

In the imaging system 200 according to the embodiment, light from the display image data I displayed on the display device 100 may affect the imaging data acquired by the imaging device 300. The following describes a method of acquiring the imaging data in the imaging system 200 according to the embodiment.

### First Embodiment

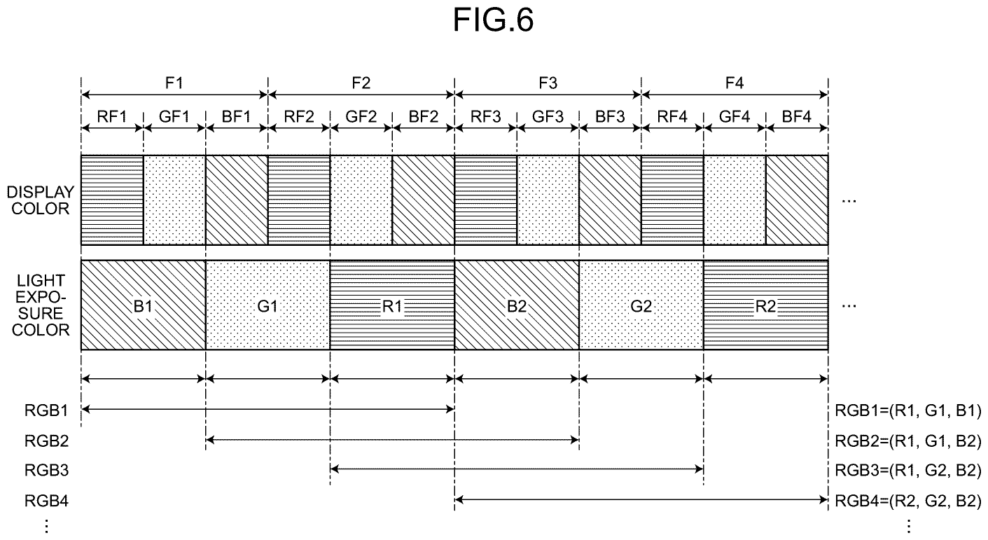

FIG. 6 is a timing chart illustrating a relation between the image display timing and the acquisition timing of the imaging data according to the first embodiment.

In the example illustrated in FIG. 6, the image display timing in the display device 100 is the same as the timing chart described in FIG. 4. The image display period of one frame (the one-frame period F) is temporally divided into the first subframe period RF, the second subframe period GF, and the third subframe period BF.

FIG. 6 exemplarily illustrates frame period F1, F2, F3, and F4 over four frames. The frame period F1 is temporally divided into a first subframe period RF1, a second subframe period GF1, and a third subframe period BF1.

The frame period F2 is temporally divided into a first subframe period RF2, a second subframe period GF2, and a third subframe period BF2.

The frame period F3 is temporally divided into a first subframe period RF3, a second subframe period GF3, and a third subframe period BF3.

The frame period F4 is temporally divided into a first subframe period RF4, a second subframe period GF4, and a third subframe period BF4.

Controlling the synchronization of the image display timing in the display device 100 with the acquisition timing (a light exposure timing) of the imaging data in the imaging device 300 is performed by the display device 100, for example. In this case, a synchronization signal output from the display device 100 is input to the imaging device 300 (refer to FIG. 1). The synchronization control is not limited to be performed by the display device 100. The controlling the synchronization of the image display timing in the display device 100 with the acquisition timing (the light exposure timing) of the imaging data in the imaging device 300 may be performed by the imaging device 300, for example. In this case, the synchronization signal output from the imaging device 300 is input to the display device 100.

In the example illustrated in FIG. 6, the imaging device 300 first acquires light exposure data B1 of the third color (blue (B)) in the first subframe period RF1 in which the first color (red (R)) is displayed, and in the second subframe period GF1 in which the second color (green (G)) is displayed in the frame period F1 on the display device 100. The acquired light exposure data B1 of the third color (blue (B)) is different from the display colors (the first color (red (R)) and the second color (green (G))) in the two subframe periods.

The imaging device 300 then acquires light exposure data G1 of the second color (green (G)) in the third subframe period BF1 in which the third color (blue (B)) is displayed in the frame period F1, and in the first subframe period RF2 in which the first color (red (R)) is displayed in the frame period F2 on the display device 100. The acquired light exposure data G1 is different from the display colors (the third color (blue (B)) and the first color (red (R))) in the two subframe periods.

The imaging device 300 then acquires light exposure data R1 of the first color (red (R)) in the second subframe period GF2 in which the second color (green (G)) is displayed, and in the third subframe period BF2 in which the third color (blue (B)) is displayed in the frame period F2 on the display device 100. The acquired light exposure data R1 is different from the display colors (the second color (green (G)) and the third color (blue (B))) in the two subframe periods.

The imaging device 300 combines the light exposure data R1 of the first color (red (R)), the light exposure data G1 of the second color (green (G)), and the light exposure data B1 of the third color (blue (B)) to generate imaging data RGB1 (=R1, G1, B1).

The imaging device 300 then acquires light exposure data B2 of the third color (blue (B)) in the first subframe period RF3 in which the first color (red (R)) is displayed, and in the second subframe period GF3 in which the second color (green (G)) is displayed in the frame period F3 on the display device 100. The acquired light exposure data B2 is different from the display colors (the first color (red (R)) and the second color (green (G))) in the two subframe periods.

The imaging device 300 combines the light exposure data R1 of the first color (red (R)), the light exposure data G1 of the second color (green (G)), and the light exposure data B2 of the third color (blue (B)) to generate imaging data RGB2 (=R1, G1, B2).

The imaging device 300 then acquires light exposure data G2 of the second color (green (G)) in the third subframe period BF3 in which the third color (blue (B)) is displayed in the frame period F3, and the first subframe period RF4 in which the first color (red (R)) is displayed in the frame period F4 on the display device 100. The acquired light exposure data G2 is different from the display colors (the third color (blue (B)) and the first color (red (R))) in the two subframe periods.

The imaging device 300 combines the light exposure data R1 of the first color (red (R)), the light exposure data G2 of the second color (green (G)), and the light exposure data B2 of the third color (blue (B)) to generate imaging data RGB3 (=R1, G2, B2).

The imaging device 300 then acquires light exposure data R2 of the first color (red (R)) in the second subframe period GF4 in which the second color (green (G)) is displayed, and in the third subframe period BF4 in which the third color (blue (B)) is displayed in the frame period F4 on the display device 100. The acquired light exposure data R2 is different from the display colors (the second color (green (G)) and the third color (blue (B))) in the two subframe periods.

The imaging device 300 combines the light exposure data R2 of the first color (red (R)), the light exposure data G2 of the second color (green (G)), and the light exposure data B2 of the third color (blue (B)) to generate imaging data RGB4 (=R2, G2, B2).

Thereafter, in the same manner, the imaging device 300 acquires imaging data RGB5, RGB6, . . . . As a result, when the display device 100 displays the display image data I at 60 FPS, the imaging device 300 can capture the imaging data of the object to be imaged PA at 90 FPS.

As described above, in the acquisition timing of the imaging data according to the first embodiment, the imaging device 300 captures the light exposure data of the color different from the display colors on the display device 100 in the two subframe periods. The imaging device 300 combines pieces of light exposure data acquired in the multiple subframe periods to generate the imaging data of the object to be imaged PA. This prevents light of the display image data I displayed on the display device 100 from affecting the imaging data acquired by the imaging device 300, thus making it possible to display high quality remote images.

### Second Embodiment

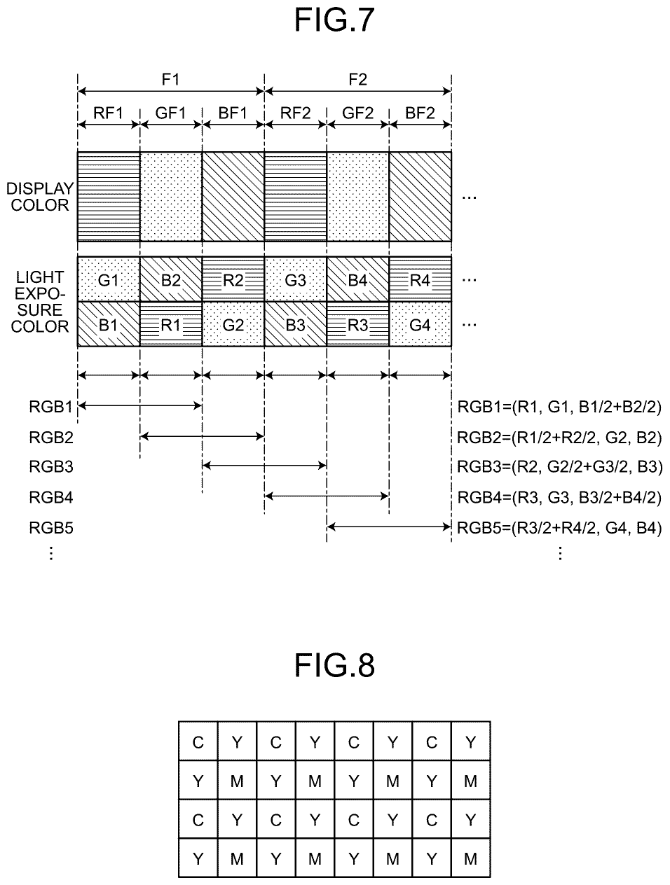

FIG. 7 is a timing chart illustrating a relation between the image display timing and the acquisition timing of the imaging data according to a second embodiment.

In the example illustrated in FIG. 7, the image display timing in the display device 100 is the same as the timing chart described in FIG. 4 in the first embodiment. The image display period of one frame (the one-frame period F) is temporally divided into the first subframe period RF, the second subframe period GF, and the third subframe period BF.

FIG. 7 exemplarily illustrates the frame periods F1 and F2 over two frames. The frame period F1 is temporally divided into the first subframe period RF1, the second subframe period GF1, and the third subframe period BF1.

The frame period F2 is temporally divided into the first subframe period RF2, the second subframe period GF2, and the third subframe period BF2.

In the example illustrated in FIG. 7, the imaging device 300 first acquires the light exposure data G1 of the second color (green (G)), and the light exposure data B1 of the third color (blue (B)) in the first subframe period RF1 in the first period F1. The second and the third colors are different from the display color (the first color (red (R))) on the display device 100 in the first subframe period RF1 in the frame period F1.

The imaging device 300 then acquires the light exposure data B2 of the third color (blue (B)), and the light exposure data R1 of the first color (red (R)) in the second subframe period GF1 in the frame period F1. The third and the first colors are different from the display color (the second color (green (G))) on the display device 100 in the second subframe period GF1 in the frame period F1.

The imaging device 300 combines the light exposure data R1 of the first color (red (R)), the light exposure data G1 of the second color (green (G)), the light exposure data B1/2 corresponding to the third color (blue (B)), and the light exposure data B2/2 corresponding to the third color (blue (B)) to generate the imaging data RGB1 (=R1, G1, B1/2+B2/2). The light exposure data B1/2 represents the half value of the light exposure data B1 while the light exposure data B2/2 represents the half value of the light exposure data B2. The imaging device 300 may combine the light exposure data R1 of the first color (red (R)), the light exposure data G1 of the second color (green (G)), and the light exposure data B1 of the third color (blue (B)) to generate the imaging data RGB1 (=R1, G1, B1). The imaging device 300 may combine the light exposure data R1 of the first color (red (R)), the light exposure data G1 of the second color (green (G)), and the light exposure data B2 of the third color (blue (B)) to generate the imaging data RGB1 (=R1, G1, B2).

The imaging device 300 then acquires the light exposure data R2 of the first color (red (R)) and the light exposure data G2 of the second color (green (G)) in the third subframe period BF1 in the frame period F1. The first and the second colors are different from the display color (the third color (blue (B))) on the display device 100 in the third subframe period BF1 in the frame period F1.

The imaging device 300 combines the light exposure data R1/2 corresponding to the first color (red (R)), the light exposure data R2/2 corresponding to the first color (red (R)), the light exposure data G2 of the second color (green (G)), and the light exposure data B2 of the third color (blue (B)) to generate the imaging data RGB2 (=R1/2+R2/2, G2, B2). The light exposure data R1/2 represents the half value of the light exposure data R1 while the light exposure data R2/2 represents the half value of the light exposure data R2. The imaging device 300 may combine the light exposure data R1 of the first color (red (R)), the light exposure data G2 of the second color (green (G)), and the light exposure data B2 of the third color (blue (B)) to generate the imaging data RGB2 (=R1, G2, B2). The imaging device 300 may combine the light exposure data R2 of the first color (red (R)), the light exposure data G2 of the second color (green (G)), and the light exposure data B2 of the third color (blue (B)) to generate the imaging data RGB2 (=R2, G2, B2).

The imaging device 300 then acquires the light exposure data G3 of the second color (green (G)) and the light exposure data B3 of the third color (blue (B)) in the first subframe period RF2 in the frame period F2. The second and the third colors are different from the display color (the first color (red (R))) on the display device 100 in the first subframe period RF2 in the frame period F2.

The imaging device 300 combines the light exposure data R2 of the first color (red (R)), the light exposure data G2/2 corresponding to the second color (green (G)), the light exposure data G3/2 corresponding to the second color (green (G)), and the light exposure data B3 of the third color (blue (B)) to generate the imaging data RGB3 (=R2, G2/2+G3/2, B3). The light exposure data G2/2 represents the half value of the light exposure data G2 while the light exposure data G3/2 represents the half value of the light exposure data G3. The imaging device 300 may combine the light exposure data R2 of the first color (red (R)), the light exposure data G2 of the second color (green (G)), and the light exposure data B3 of the third color (blue (B)) to generate the imaging data RGB3 (=R2, G2, B3). The imaging device 300 may combine the light exposure data R2 of the first color (red (R)), the light exposure data G3 of the second color (green (G)), and the light exposure data B3 of the third color (blue (B)) to generate the imaging data RGB3 (=R2, G3, B3).

The imaging device 300 then acquires the light exposure data B4 of the third color (blue (B)), and the light exposure data R3 of the first color (red (R)) in the second subframe period GF2 in the frame period F2. The third and the first colors are different from the display color (the second color (green (G))) on the display device 100 in the second subframe period GF2 in the frame period F2.

The imaging device 300 combines the light exposure data R3 of the first color (red (R)), the light exposure data G3 of the second color (green (G)), the light exposure data B3/2 corresponding to the third color (blue (B)), and the light exposure data B4/2 corresponding to the third color (blue (B)) to generate the imaging data RGB4 (=R3, G3, B3/2+B4/2). The light exposure data B3/2 represents the half value of the light exposure data B3 while the light exposure data B4/2 represents the half value of the light exposure data B4. The imaging device 300 may combine the light exposure data R3 of the first color (red (R)), the light exposure data G3 of the second color (green (G)), and the light exposure data B3 of the third color (blue (B)) to generate the imaging data RGB4 (=R3, G3, B3). The imaging device 300 may combine the light exposure data R3 of the first color (red (R)), the light exposure data G3 of the second color (green (G)), and the light exposure data B4 of the third color (blue (B)) to generate the imaging data RGB4 (=R3, G3, B4).

The imaging device 300 then acquires the light exposure data R4 of the first color (red (R)) and the light exposure data G4 of the second color (green (G)) in the third subframe period BF2 in the frame period F2. The first and the second colors are different from the display color (the third color (blue (B))) on the display device 100 in the third subframe period BF2 in the frame period F2.

The imaging device 300 combines the light exposure data R3/2 corresponding to the first color (red (R)), the light exposure data R4/2 corresponding to the first color (red (R)), the light exposure data G4 of the second color (green (G)), and the light exposure data B4 of the third color (blue (B)) to generate the imaging data RGB5 (=R3/2+R4/2, G4, B4). The light exposure data R3/2 represents the half value of the light exposure data R3 while the light exposure data R4/2 represents the half value of the light exposure data R4. The imaging device 300 may combine the light exposure data R3 of the first color (red (R)), the light exposure data G4 of the second color (green (G)), and the light exposure data B4 of the third color (blue (B)) to generate the imaging data RGB5 (=R3, G4, B4). The imaging device 300 may combine the light exposure data R4 of the first color (red (R)), the light exposure data G4 of the second color (green (G)), and the light exposure data B4 of the third color (blue (B)) to generate the imaging data RGB5 (=R4, G4, B4).

Thereafter, in the same manner, the imaging device 300 acquires imaging data RGB6, RGB7, . . . . As a result, when the display device 100 displays the display image data I at 60 FPS, the imaging device 300 can capture the imaging data of the object to be imaged PA at 180 FPS.

As described above, in the acquisition timing of the imaging data according to the second embodiment, the imaging device 300 captures the pieces of light exposure data of the colors different from the display color on the display device 100 in each subframe period. The pieces of data acquired in the multiple subframe periods are then combined to generate the imaging data of the object to be imaged PA. This prevents light of the display image data I displayed on the display device 100 from affecting the imaging data acquired by the imaging device 300, thus making it possible to display high quality remote images.

### Modification

FIG. 8 is a diagram illustrating a color filter array of the image sensor according to a modification. The color filter array of the image sensor illustrated in FIG. 8 exemplarily illustrates the Bayer array. The Bayer array consists of three complementary color filters of yellow (Y), cyan (C), and magenta (M). A combination of four C/Y/Y/M pixels is regularly repeated. Specifically, the cyan (C) filter, the magenta (M) filter, and two yellow (Y) filters are arranged in 2×2 pixels. Instead of the color filter array of the image sensor illustrated in FIG. 8, an array may be employed in which the combination of four C/Y/G/M pixels is regularly repeated (specifically, the cyan (C) filter, the yellow (Y) filter, the green (G) filter, and the magenta (M) filter are arranged in 2×2 pixels).

When the imaging device 300 has the image sensor having the color filters consisting of the complementary color filters as illustrated in FIG. 8, the image display period of one frame (the one-frame period) based on the display image data I may be temporally divided into a first subfield period in which the first light source 11R and the second light source 11G emit light to display yellow (Y), a second subfield period in which the second light source 11G and the third light source 11B emit light to display cyan (C), and a third subfield period in which the third light source 11B and the first light source 11R emit light to display magenta (M).

The imaging device 300 having this configuration captures the light exposure data of a color different from the display colors on the display device 100 in the two subframe periods in the same manner as the first embodiment. The imaging device 300 combines pieces of light exposure data acquired in the multiple subframe periods to generate the imaging data of the object to be imaged PA. This prevents light of the display image data I displayed on the display device 100 from affecting the imaging data acquired by the imaging device 300, thus making it possible to display high quality remote images.

The imaging device 300 captures the light exposure data of colors different from the display color on the display device 100 in each subframe period in the same manner as the second embodiment. The imaging device 300 combines pieces of light exposure data acquired in the multiple subframe periods to generate the imaging data of the object to be imaged PA. This prevents light of the display image data I displayed on the display device 100 from affecting the imaging data acquired by the imaging device 300, thus making it possible to display high quality remote images.

Alternatively, when the imaging device 300 has the image sensor having the color filters consisting of the complementary color filters as illustrated in FIG. 8, the image display period of one frame (the one-frame period) based on the display image data I may be temporally divided into a first subfield period in which the first light source 11R emits light to display the first color (red (R)), a second subfield period in which the second light source 11G emits light to display the second color (green (G)), and a third subfield period in which the third light source 11B emits light to display third color (blue (B)) in the same manner as the first and the second embodiments.

The imaging device 300 having this configuration captures the light exposure data of a color different from the display colors on the display device 100 in the two subframe periods in the same manner as the first embodiment.

Specifically, the imaging device 300 acquires the light exposure data of cyan (C) (the fourth color), which is the complementary color of red (R) (the first color), in the first subfield period in which the red (R) (the first color) is displayed in the first frame. The imaging device 300 acquires the light exposure data of magenta (M) (the fifth color), which is the complementary color of green (G) (the second color), in the second subfield period in which green (G) (the second color) is displayed in the first frame, for example. Then, the imaging device 300 extracts the light exposure data of blue (B) (the third color) from each of the light exposure data of cyan (C) (the fourth color) acquired in the first subfield period in the first frame and the light exposure data of magenta (M) (the fifth color) acquired in the second subfield period in the first frame.

The imaging device 300 acquires the light exposure data of yellow (Y) (the sixth color), which is the complementary color of blue (B) (the third color), in the third subfield period in which blue (B) (the third color) is displayed in the first frame, and acquires the light exposure data of cyan (C) (the fourth color), which is the complementary color of red (R) (the first color), in the first subfield period in which red (R) (the first color) is displayed in the second frame, for example. Then, the imaging device 300 extracts the light exposure data of green (G) (the second color) from each of the light exposure data of yellow (Y) (the sixth color) acquired in the first subfield period in the first frame and the light exposure data of cyan (C) (the fourth color) acquired in the first subfield period in the second frame.

The imaging device 300 acquires the light exposure data of magenta (M) (the fifth color), which is the complementary color of green (G) (the second color), in the second subfield period in which green (G) (the second color) is displayed in the second frame, and acquires the light exposure data of yellow (Y) (the sixth color), which is the complementary color of blue (B) (the third color), in the third subfield period in which blue (B) (the third color) is displayed in the second frame, for example. Then, the imaging device 300 extracts the light exposure data of red (R) (the first color) from each of the light exposure data of magenta (M) (the fifth color) acquired in the second subfield period in the second frame and the light exposure data of yellow (Y) (the sixth color) acquired in the third subfield period in the second frame.

The pieces of light exposure data acquired in the multiple subframe periods are then combined to generate the imaging data of the object to be imaged PA. This prevents light of the display image data I displayed on the display device 100 from affecting the imaging data acquired by the imaging device 300, thus making it possible to display high quality remote images.

The imaging device 300 captures the light exposure data of colors different from the display color on the display device 100 in each subframe period in the same manner as the second embodiment.

Specifically, the imaging device 300 acquires the light exposure data of cyan (C) (the fourth color), which is the complementary color of red (R) (the first color), in the first subfield period in which the red (R) (the first color) is displayed in the first frame, and extracts the light exposure data of green (G) (the second color) and the light exposure data of blue (B) (the third color) from the acquired light exposure data of cyan (C) (the fourth color), for example.

The imaging device 300 acquires the light exposure data of magenta (M) (the fifth color), which is the complementary color of green (G) (the second color), in the second subfield period in which the green (G) (the second color) is displayed in the first frame, and extracts the light exposure data of blue (B) (third color) and the light exposure data of red (R) (first color) from the acquired light exposure data of magenta (M) (fifth color), for example.

The imaging device 300 acquires the light exposure data of yellow (Y) (the sixth color), which is the complementary color of blue (B) (the third color), in the third subfield period in which blue (B) (the third color) is displayed in the first frame, and extracts the light exposure data of red (R) (the first color) and the light exposure data of green (G) (the second color) from the acquired light exposure data of yellow (Y) (the sixth color), for example.

The imaging device 300 combines pieces of light exposure data acquired in the multiple subframe periods to generate the imaging data of the object to be imaged PA. This prevents light of the display image data I displayed on the display device 100 from affecting the imaging data acquired by the imaging device 300, thus making it possible to display high quality remote images.

The preferred embodiments of the present disclosure are described above. The present disclosure is not limited to such embodiments. The contents disclosed in the embodiments are only examples and various modifications can be made without departing from the purpose of the present disclosure. For example, appropriate modifications made within the scope that does not depart from the purpose of the present disclosure naturally belong to the technical scope of the invention.

What is claimed is:

1. An imaging system, comprising:
a display device that has a display panel; and
an imaging device that is disposed such that the display panel is interposed between an object to be imaged and the imaging device, and takes an image of the object to be imaged, the image being transmitted through the display panel, wherein
the imaging device acquires light exposure data of a color different from a display color on the display device to generate imaging data of the object to be imaged.

2. The imaging system according to claim 1, wherein
the display device temporally divides a one-frame period in which image data of one frame is displayed on the display panel into a plurality of subframe periods in each of which a different color is displayed, and
the imaging device combines a plurality of pieces of light exposure data of a plurality of colors acquired in the subframe periods to generate the imaging data.

3. The imaging system according to claim 2, wherein the display device temporally divides the one-frame period into a first subframe period in which a first color is displayed, a second subframe period in which a second color is displayed, the second color being different from the first color, and a third subframe period in which a third color is displayed, the third color being different from the first and the second colors.

4. The imaging system according to claim 3, wherein
the display device has a light source that emits light to a side of the display panel, and
the light source includes:
a first light source that emits light at least in the first subframe period;
a second light source that emits light at least in the second subframe period; and
a third light source that emits light at least in the third subframe period.

5. The imaging system according to claim 4, wherein the imaging device has an image sensor that includes color filters that each selectively transmit the first, the second, and the third colors.

6. The imaging system according to claim 5, wherein
the first color is red,
the second color is green, and
the third color is blue.

7. The imaging system according to claim 5, wherein
the first color is yellow,
the second color is cyan, and
the third color is magenta.

8. The imaging system according to claim 4, wherein the imaging device has an image sensor that includes color filters that each selectively transmit a fourth color that is a complementary color of the first color, a fifth color that is the complementary color of the second color, and a sixth color that is the complementary color of the third color.

9. The imaging system according to claim 8, wherein
the first color is red,
the second color is green, and
the third color is blue.

10. The imaging system according to claim 6, wherein the imaging device acquires
the light exposure data of the third color in the first subframe period and the second subframe period following the first subframe period,
the light exposure data of the second color in the third subframe period and the first subframe period following the third subframe period, and
the light exposure data of the first color in the second subframe period and the third subframe period following the second subframe period.

11. The imaging system according to claim 10, wherein the imaging device combines the light exposure data of the first color, the light exposure data of the second color, and the light exposure data of the third color that are consecutively acquired to generate the imaging data.

12. The imaging system according to claim 6, wherein
the imaging device acquires
the light exposure data of the second and the third colors in the first subframe period,
the light exposure data of the third and the first colors in the second subframe period, and
the light exposure data of the first and the second colors in the third subframe period.

13. The imaging system according to claim 12, wherein the imaging device combines the light exposure data of the second and the third colors acquired in the first subframe period and the light exposure data of the third and the first colors acquired in the second subframe period following the first subframe period to generate the imaging data.

14. The imaging system according to claim 12, wherein the imaging device combines the light exposure data of the third and the first colors acquired in the second subframe period and the light exposure data of the first and the second colors acquired in the third subframe period following the second subframe period to generate the imaging data.

15. The imaging system according to claim 12, wherein the imaging device combines the light exposure data of the first and the second colors acquired in the third subframe period and the light exposure data of the second and the third colors acquired in the first subframe period following the third subframe period to generate the imaging data.

16. The imaging system according to claim 12, wherein the imaging device combines the light exposure data of the second color acquired in the first subframe period and the light exposure data of the third and the first colors acquired in the second subframe period following the first subframe period to generate the imaging data.

17. The imaging system according to claim 12, wherein the imaging device combines the light exposure data of the third color acquired in the second subframe period and the light exposure data of the first and the second colors acquired in the third subframe period following the second subframe period to generates the imaging data.

18. The imaging system according to claim 12, wherein the imaging device combines the light exposure data of the first color acquired in the third subframe period and the light exposure data of the second and the third colors acquired in the first subframe period following the third subframe period to generate the imaging data.

19. The imaging system according to claim 12, wherein the imaging device combines the light exposure data of the second and the third colors acquired in the first subframe period and the light exposure data of the first color acquired in the second subframe period following the first subframe period to generate the imaging data.

20. The imaging system according to claim 12, wherein the imaging device combines the light exposure data of the third and the first colors acquired in the second subframe period and the light exposure data of the second color acquired in the third subframe period following the second subframe period to generate the imaging data.

21. The imaging system according to claim 12, wherein the imaging device combines the light exposure data of the first and the second colors acquired in the third subframe period and the light exposure data of the third color acquired in the first subframe period following the third subframe period to generate the imaging data.
